(19) United States
(12) Patent Application Publication
(10) Pub. No.: US 2010/0255451 A1
(43) Pub. Date: Oct. 7, 2010

(54) Wrist bracelet motivational system

(76) Inventor: Melissa Jill Shapiro, Miami, FL (US)

Correspondence Address: GOAL PATROL, LLC/ Melissa Shapiro, P.O. BOX 31-0278, Miami, FL, 33231, US

(21) Appl. No.: 12/384,445

(22) Filed: Apr. 6, 2009

(51) Int. Cl. G09B 19/00; A44C 25/00

(52) U.S. Cl. 434/238; 63/33

(57) ABSTRACT

A motivational system that utilizes wrist bracelets to represent steps or sub-goals and the achievement of a measurable goal. This system includes the method of breaking down a measurable goal into steps or sub-goals and marking them successively with respective wrist bracelets that represent each successive step or sub-goal. As an individual is achieving or surpassing successive steps or sub-goals a respective bracelet is added or removed from their wrist and a successive bracelet is added or removed to thereby signify that individual's advancement toward or achievement of their goal.

### FIELD OF INVENTION

This invention relates to a motivational system that utilizes wrist bracelets to represent steps or sub-goals and the achievement of a measurable goal. This system includes the method of breaking down a measurable goal into steps or sub-goals and marking them successively with respective wrist bracelets that represent each successive step or sub-goal.

### BACKGROUND OF THE INVENTION

Measurable goals have a greater chance of being achieved with a supporting motivational system. People with measurable goals, especially long-term measurable goals, have the tendency to sometimes become discouraged prior to ever reaching their goals. They start to feel like the possibility of attaining their goal is impossible and the temptation to give up is inevitable. One solution to the former issue is the common practice of breaking down measurable goals into successive steps or mini goals, hereinafter referred to as sub-goals. This method is effective because achieving these sub-goals is far less intimidating than achieving the ultimate goal. Moreover, once each sub-goal is successfully attained, there is more motivation to continue on to achieve greater success and conquer the following sub-goal, until the ultimate goal is finally achieved. Although this method of breaking up goals is very motivating on its own, the addition of a constant reminder and tracking system to support this method can offer a better chance for success.

### SUMMARY OF THE INVENTION

Wrist bracelets are normally worn on the wrists as a fashion accessory. This can also be true for the instant bracelets of this invention. However, the main purpose of the instant invention is to function as a motivational tool. Therefore, it is imperative for these wrist bracelets to be worn in a highly visible location, such as the wrist area, where they can fulfill their function of constantly reminding an individual of the present goal, resulting in constant motivation. The instant invention includes a plurality of wrist bracelets that represent respective sub-goals of a measurable goal, wherein respective wrist bracelets are either added or removed subsequent to the attainment of each respective sub-goal.

The instant invention is designed as a motivational system incorporating a method of breaking down a measurable goal into sub-goals in combination with the use of wrist bracelets to represent successive sub-goals. The invention will provide a constant visible reminder that a goal exists. The invention will also promote self-awareness.

The instant invention provides a goal tracking system whereby users can constantly and visibly track their progress towards reaching their desired, measurable goals. Each respective wrist bracelet exclusively represents a particular sub-goal such that an individual can constantly and visibly track his or her progress towards the ultimate goal by simply looking at the wrist bracelet or bracelets worn at any given moment. This will allow the person to evaluate both the number of sub-goals accomplished and the number of sub-goals remaining towards reaching the ultimate goal. The invention's constant reminder and tracking system will enhance the degree of motivation provided by the existing method of breaking down measurable goals into sub-goals. When measurable goals are broken down into sub-goals the exhilaration of achievement at every milestone motivates one to achieve greater success and conquer the following sub-goal until the ultimate goal is achieved. The addition of a constant reminder and tracking system will provide even further motivation.

The instant invention will help people reach their goals; will help people overcome the obstacles and fears towards reaching goals; will help people overcome the obstacles and fears towards reaching long-term measurable goals; will help people overcome the obstacles and fears towards reaching short-term measurable goals; will provide a public display of a self-perceived level of attainment; will provide a rewarding reminder of a sub-goal that has been attained; will provide a reminder of a sub-goal that remains to be attained; will provide a rewarding reminder of a goal that has been attained; and will provide a confidential indication of a current personal goal.

The instant invention may alternatively be used as a countdown system to a specific deadline or calendar date wherein each wrist bracelet represents successive specific amounts of time towards the date. Instead of being used for motivational purposes, the wrist bracelets provide emotional support all the way through until the arrival date of the event. In said alternative use where the invention is used as a countdown to a specific deadline or calendar date, the wrist bracelets serve as constant reminders and tracking devices for that important date.

An alternative to the current invention is for the wrist bracelets to represent the sub-goals of a measurable goal whereby an additional wrist bracelet is added on to the wrist upon completion of each sub-goal of a measurable goal. And if the user should backtrack during the journey towards reaching his or her ultimate goal then the user would remove the wrist bracelet representing the sub-goal in progress. With this alternative method, the user would begin by wearing one or zero wrist bracelet(s). If the user begins with wearing one wrist bracelet on the wrist prior to any accomplishment of a sub-goal, this first applied wrist bracelet solely represents that the first sub-goal is in progress. Thus, every wrist bracelet added on to the wrist thereafter represents both the accomplishment of the previous sub-goal and that the successive sub-goal is in progress. As an example, if the ultimate goal were to be broken down into five sub-goals total, the user would end with five wrist bracelets on the wrist while sub-goal five is in progress. Then, upon completion of sub-goal five, the user could leave all the wrist bracelets on the wrist as a visual reminder of his or her success. If the user begins by wearing zero wrist bracelets on the wrist, the first wrist bracelet is added on to the wrist once the first sub-goal is accomplished. Thus, the first wrist bracelet added on to the wrist represents both the accomplishment of the first sub-goal and that the second sub-goal is in progress. And each wrist bracelet added to the wrist thereafter represents both the accomplishment of the previous sub-goal and that the successive sub-goal is in progress. As an example, if the ultimate goal were to be broken down into five sub-goals total, the user would end with five wrist bracelets on the wrist only after sub-goal five is accomplished. Then, the user could leave all the wrist bracelets on the wrist as a visual reminder of his or her success.

Some people may find it more inspiring to accumulate more and more wrist bracelets onto their wrist. The increasing quantity of wrist bracelets on their wrist constantly reminds them of the increasing quantity of sub-goals they have accomplished and how far they are from reaching their ultimate goal. The total number of sub-goals that the measurable goal is broken up into is the total number of wrist bracelets the user aims to end up with on their wrist. The wrist bracelets continue to serve as reminders, motivators, and as a tracking device.

With the former alternative version, the same method could be applied to a situation whereby one doesn't even have a definitive ultimate goal. Each wrist bracelet could simply represent an equal specific quantity of anything whereby each accomplishment of that specific quantity leads to a more positive outcome. For example, each wrist bracelet could represent a specific amount of sales in a situation whereby there is no existent definitive ultimate goal or targeted amount of sales. The quantity of wrist bracelets added on to the wrist could add up to infinity. The wrist bracelets continue to serve as reminders, motivators, and as a tracking device.

An alternative to the current invention is for the wrist bracelets to represent the sub-goals of a measurable goal, whereby the wrist bracelets are removed from the wrist upon completion of each sub-goal; and, if the user should backtrack during the journey towards reaching his or her ultimate goal, then the user would place back on the wrist the wrist bracelet representing the previous sub-goal. With this alternative method, the user would begin by wearing the number of wrist bracelets representing the number of sub-goals needed to accomplish the ultimate goal; and, the user would end with zero wrist bracelets on the wrist once the last sub-goal is accomplished. Some people may find it more inspiring to get rid of the bulk from the plurality of wrist bracelets on the wrist. Thus, the user aims to remove the disturbing wrist bracelets from his or her wrist while simultaneously moving closer and closer towards reaching the ultimate goal. The wrist bracelets continue to serve as reminders, motivators, and as a tracking device.

### BRIEF DESCRIPTION OF THE DRAWINGS

FIG. 1 illustrates the progression of five sub-goals using five bracelets, wherein each successive bracelet highlights the sub-goal number in progress.

FIG. 2 illustrates the progression of three sub-goals using three bracelets, wherein each successive bracelet highlights the sub-goal number in progress.

FIG. 3 illustrates an optional extra bracelet signifying the accomplishment of the main goal.

FIG. 4 shows an example of a user wearing a sub-goal 3 bracelet within the five sub-goal bracelet system, thereby signifying that the third sub-goal is in progress.

FIG. 5 shows a user wearing all five sub-goal bracelets in the five sub-goal bracelet system, wherein when each sub-goal is achieved that respective bracelet is removed from the user's wrist.

FIG. 6 shows an example of the five sub-goal bracelet system packaged and ready for sale.

### DESCRIPTION OF THE PREFERRED EMBODIMENT

The preferred embodiment of the current invention is in the form of a motivational system that includes breaking down a measurable goal into steps or sub-goals that are signified by successive wrist bracelets that are worn one at a time to represent respective successive steps or sub-goals of the measurable main goal.

In the preferred embodiment, each wrist bracelet uniquely represents one of the sub-goals that is in progress towards the chosen, ultimate goal. Thus, if the ultimate goal is broken down into five sub-goals five different wrist bracelets are involved. And if the goal is broken down into three sub-goals three different wrist bracelets are involved. Alternatively, an additional wrist bracelet may be integrated into the present embodiment if said additional wrist bracelet is used exclusively to represent the victory of reaching the ultimate goal.

Once the user determines the number of sub-goals involved in his or her goal, the user must apply an individual value to each of the sub-goals. The sub-goals may be given equal or unequal values. Operating with equal sub-goals is the preferred approach. This makes it easier for the user to remember each wrist bracelet's value and will also allow the user to accurately track the true distance from the ultimate goal. To apply equal values to the sub-goals the user simply divides the ultimate goal by the number of sub-goals. Once the sub-goals have been defined, the user begins by wearing the wrist bracelet representing the first sub-goal. As each sub-goal is accomplished, the user replaces the wrist bracelet he or she is wearing for the wrist bracelet representing the next sub-goal. Both the ability to continuously track the progress and the experience of exhilaration of achievement at every milestone motivates the user to continue to pursue the following sub-goals. The user is always reminded and motivated to reach the ultimate goal.

If the user should backtrack to the previous sub-goal, which is most likely caused by failure to wear the bracelets, then he or she replaces the wrist bracelet he or she is wearing for the wrist bracelet representing the previous sub-goal. This causes the user to feel guilty and try even harder because this wrist bracelet continuously reminds the user of the reversal in progress.

Once the final sub-goal is achieved and the ultimate goal is accomplished, the wrist bracelet representing the final sub-goal is removed from the wrist. At this point, the user should feel satisfied and content. This becomes the appropriate time to celebrate.

Should an additional wrist bracelet be incorporated into the current invention to represent victory once the ultimate goal is achieved, this additional wrist bracelet would replace the wrist bracelet representing the final sub-goal.

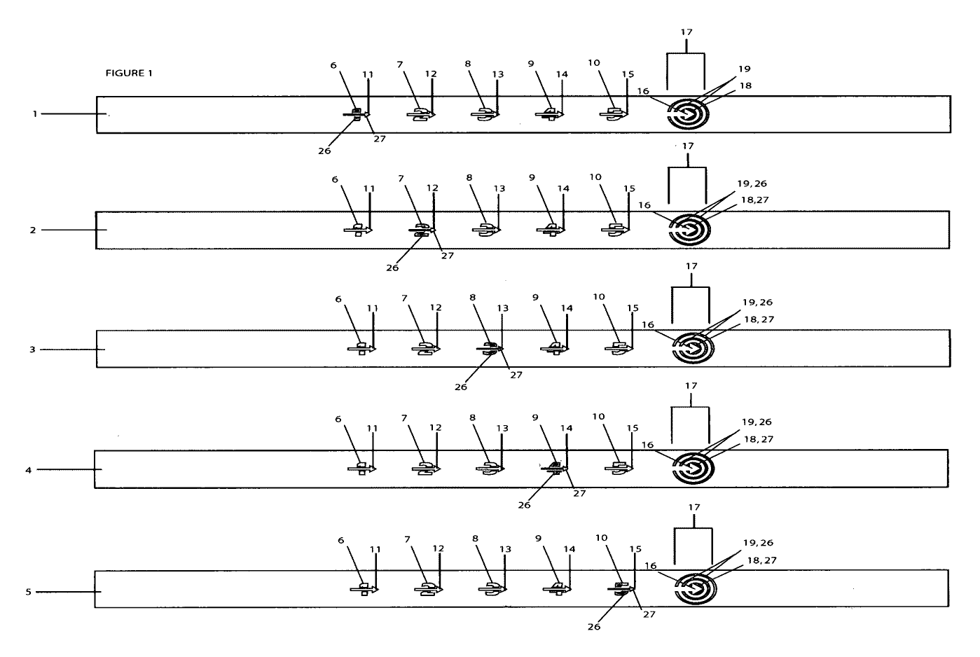

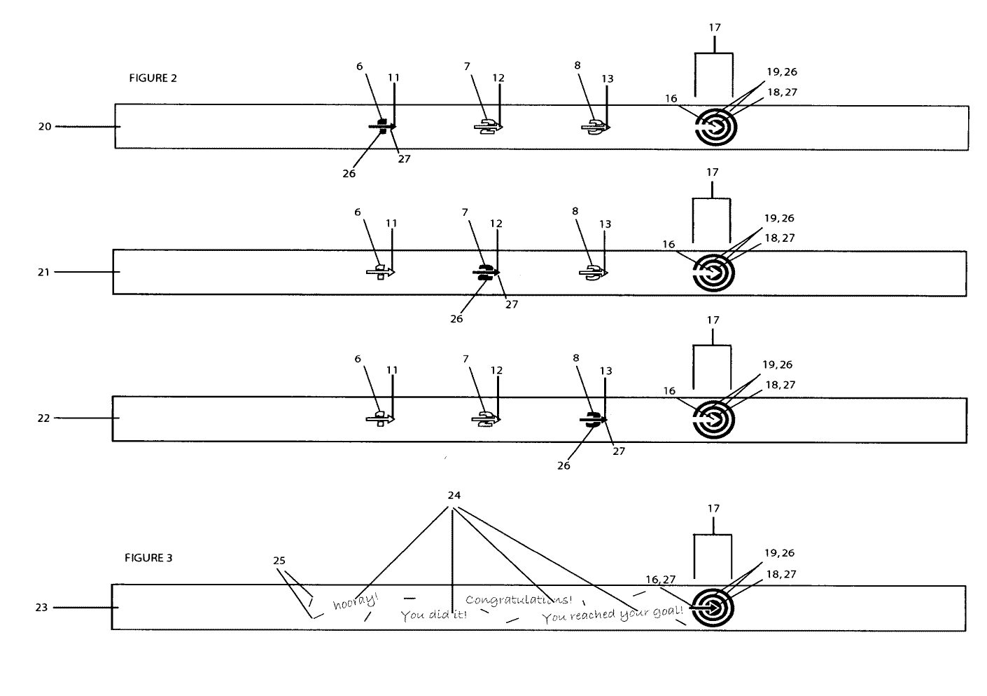

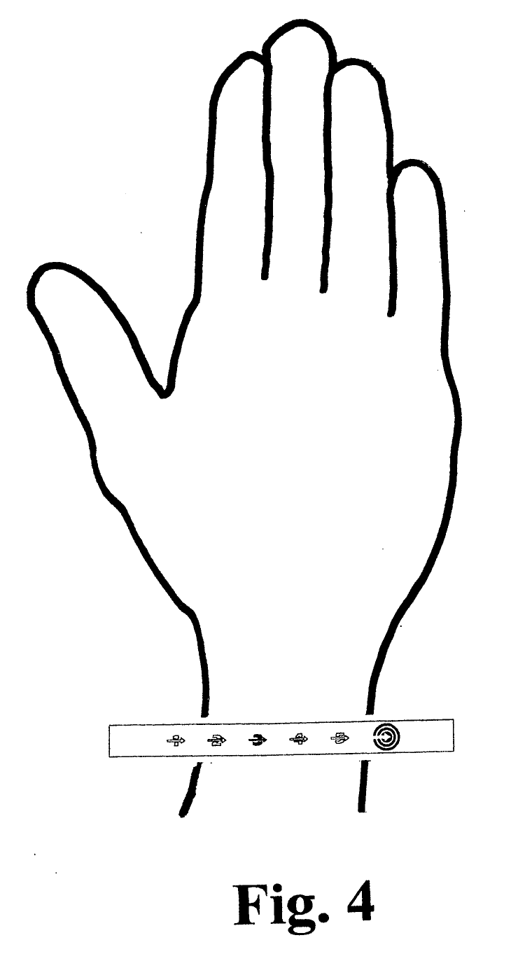

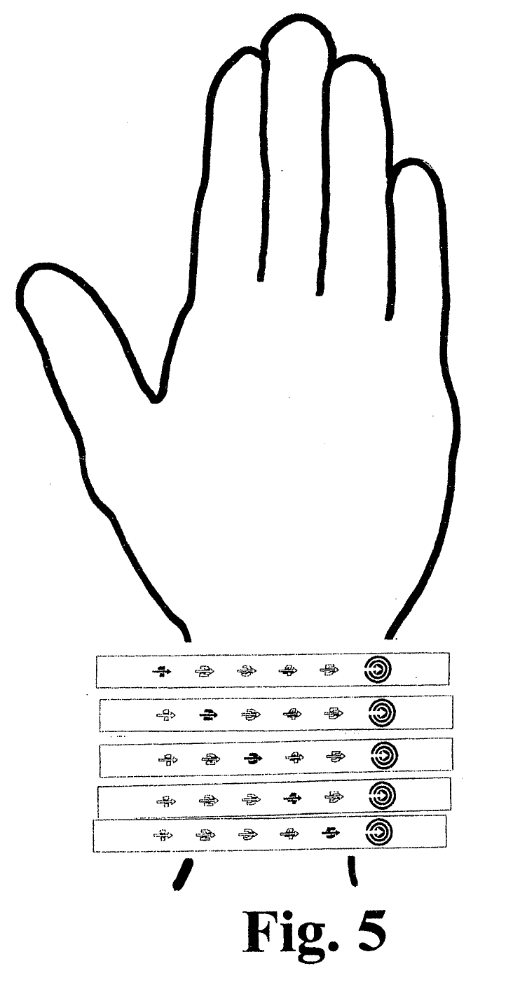

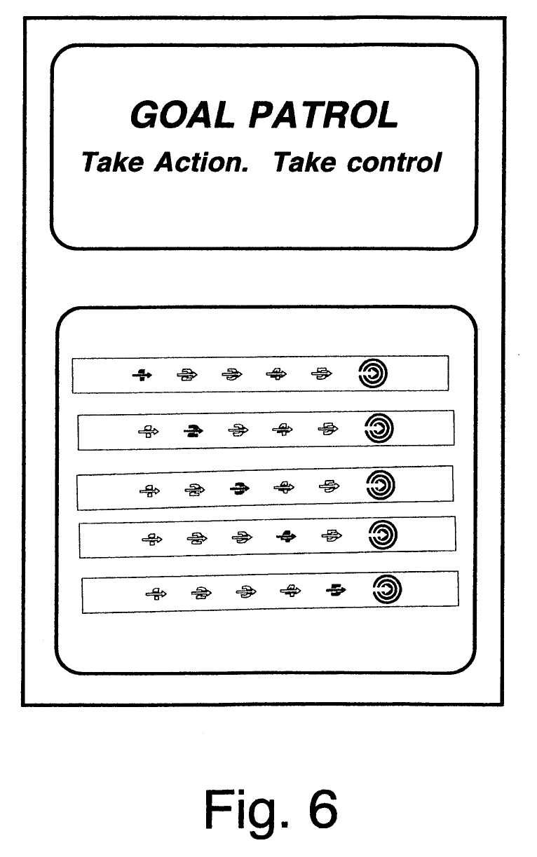

The wrist bracelets should be uniquely designed to the extent that the person wearing them can undoubtedly determine which sub-goal each wrist bracelet represents. FIGS. 1 and 2 show one way in which the wrist bracelets can be designed to sensibly represent the sub-goals of a measurable goal. FIG. 1 represents the jewelry motivational system with a goal divided into five sub-goals. Thus, in FIG. 1, each of the five wrist bracelets 1, 2, 3, 4, and 5 correspond to one of five sub-goals. Wrist bracelet 1 represents sub-goal one, wrist bracelet 2 represents sub-goal two, wrist bracelet 3 represents sub-goal three, wrist bracelet 4 represents sub-goal four, and wrist bracelet 5 represents sub-goal five. In FIG. 1, each of these wrist bracelets has identical debossed artwork. The only variation among the wrist bracelets is that each has distinctive debossed areas filled in with color so the user can easily determine which sub-goal the wrist bracelet is representing.

Each wrist bracelet design contains debossed artwork of the numbers one through five to represent sub-goals one through five. Each number on the wrist bracelet represents the number of the sub-goal; the number one 6 represents sub-goal one, the number two 7 represents sub-goal two, the number three 8 represents sub-goal three, the number four 9 represents sub-goal four, and the number five 10 represents sub-goal five.

All numbers are situated in numerical order with number one 6 furthest from the target 17 and number five 10 closest to the target 17. Because sub-goal one is furthest from the ultimate goal, the number one 6 is furthest from target 17. Because sub-goal five is closest to the ultimate goal, number five 10 is closest to target 17.

Each wrist bracelet's debossed artwork also contains six arrows. The arrow 11, the arrow 12, the arrow 13, the arrow 14, the arrow 15, and the arrow 16 all point towards the bullseye 18 of the target 17. Target 17 represents the ultimate goal.

Each of the arrows 11, 12, 13, 14, and 15 is situated in front of one of the numbers and represents the same sub-goal as the number it sits in front of. Arrow 11 is situated in front of the number one 6 and represents sub-goal one, the arrow 12 is situated in front of the number two 7 and represents sub-goal two, the arrow 13 is situated in front of the number three 8 and represents sub-goal three, the arrow 14 is situated in front the number four 9 and represents sub-goal four, and the arrow 15 is situated in front of the number five 10 and represents sub-goal five. The arrow 16, however, is situated inside of target 17, demonstrating an arrow that has successfully hit bulls eye 18 of target 17.

All of the wrist bracelets have the debossed number and arrow that represent the current sub-goal filled in with color to emphasize that the sub-goal they represent is the active sub-goal. This allows for the wrist bracelets to be easily distinguished from each other and for the user to easily follow the sequence of the wrist bracelets. The debossed number that represents the current sub-goal is filled in with color gray 26, and the debossed arrow in front of it is filled with the color yellow 27.

Debossed target 17 is also filled in with color in each of the wrist bracelets 1, 2, 3, 4, and 5, to emphasize the target 17 so it is easily visible in all wrist bracelets. In each wrist bracelet, target 17's outer rings 19 are filled in with color gray 26 and the target 17's bulls eye 18 is filled in with color yellow 27.

Because the color-filled areas for the numbers and arrows represent the current sub-goal, the user aims to get the color-filled areas of the numbers and arrows closer to the color-filled target 17. The user's attention is primarily drawn to the yellow 27 arrow in each wrist bracelet as the user aims for the yellow 27 arrow to approach the yellow 27 bulls eye 18 of the target 17.

The user begins by wearing wrist bracelet 1. Wrist bracelet 1 has the debossed area of number one 6 filled in with color gray 26 and arrow 11 filled in with color yellow 27 to differentiate the wrist bracelet 1 from wrist bracelet 2, 3, 4 and 5. Having number one 6 and arrow 11 filled in with color allows the user to easily determine that the wrist bracelet is representing sub-goal one.

Once the user completes sub-goal one, the exhilaration of achievement motivates the individual to achieve greater success and conquer the second sub-goal, represented by wrist bracelet 2. Thus the user replaces wrist bracelet 1 for wrist bracelet 2. Wrist bracelet 2 has the debossed area of number two 7 filled in with color gray 26 and arrow 12 filled in with color yellow 27 to differentiate wrist bracelet 2 from wrist bracelets 1, 3, 4 and 5; having number two 7 and arrow 12 filled in with color allows the user to easily determine that the wrist bracelet is representing sub-goal two.

Once the user completes sub-goal two, the exhilaration of achievement motivates the individual to achieve greater success and conquer the third sub-goal, represented by wrist bracelet 3. Thus, the user replaces wrist bracelet 2 for wrist bracelet 3. Wrist bracelet 3 has the debossed area of number three 8 filled in with color gray 26 and arrow 13 filled in with color yellow 27 to differentiate wrist bracelet 3 from wrist bracelets 1, 2, 4 and 5. Having number three 8 and arrow 13 filled in with color allows the user to easily determine that the wrist bracelet is representing sub-goal three.

Once the user completes sub-goal three, the experience of exhilaration of achievement motivates the individual to achieve greater success and conquer the fourth sub-goal, represented by wrist bracelet 4. Thus, the user replaces wrist bracelet 3 for wrist bracelet 4. Wrist bracelet 4 has the debossed area of number four 9 filled in with color gray 26 and arrow 14 filled in with color yellow 27 to differentiate wrist bracelet 4 from wrist bracelets 1, 2, 3, and 5. Having number four 9 and arrow 14 filled in with color allows the user to easily determine that the wrist bracelet is representing sub-goal four.

Once the user completes sub-goal four, he or she replaces wrist bracelet 4 for wrist bracelet 5. Wrist bracelet 5 has the debossed area of number five 10 filled in with color gray 26 and arrow 15 filled in with color yellow 27 to differentiate wrist bracelet 5 from wrist bracelets 1, 2, 3, and 4. Having number five 10 and arrow 15 filled in with color allows the user to easily determine that the wrist bracelet is representing sub-goal five. Once the user completes sub-goal five, the ultimate goal has been achieved. Thus, wrist bracelet 5 of FIG. 1 is removed from the wrist and no further steps are pending.

Alternatively, should an additional wrist bracelet 23 of FIG. 3 be applied to the current invention to represent victory, then the user would replace wrist bracelet 5 of FIG. 1 with said wrist bracelet 23 once the ultimate goal is achieved. Wrist bracelet 23 has the debossed area of arrow 16 filled in with color yellow 27 to differentiate wrist bracelet 23 from wrist bracelets 1, 2, 3, 4, and 5. Because arrow 16 is situated inside of bulls eye 18 of target 17, having arrow 16 filled in with color yellow 27 in wrist bracelet 23 allows the user to easily determine that the wrist bracelet 23 is representing victory. The victory wrist bracelet 23 also has debossed artwork of inspiring, positive words 24 and celebration marks 25 to further remind the user of his or her success.

The alternative additional victory bracelet can be designed an in infinity number of different ways that will allow the user to easily determine that the wrist bracelet is solely representing victory. This includes, but is not limited to, having any slightly different or erratically different debossed artwork from that of bracelet 23 of FIG. 3 whereby it is also obvious that the artwork is portraying victory, using a different color bracelet, using a different quality bracelet, and or any combination thereof.

Should an individual backtrack to the previous sub-goal at any given time, the individual should simultaneously return to the corresponding wrist bracelet. Thus, in FIG. 1, if the user backtracked from having achieved the ultimate goal, he or she would return to wearing wrist bracelet 5. If the user is in sub-goal five when he or she backtracks, then said wrist bracelet 5 is removed from the wrist and replaced by wrist bracelet 4. If the user is in sub-goal four when he or she backtracks, then said wrist bracelet 4 is removed from the wrist and replaced by wrist bracelet 3. If the user is in sub-goal three when he or she backtracks, then said wrist bracelet 3 is removed from the wrist and replaced by wrist bracelet 2. And if the user is in sub-goal two when he or she backtracks, then said wrist bracelet 2 is removed from the wrist and replaced by wrist bracelet 1.

FIG. 2 demonstrates the same debossed artwork used for the motivational system in FIG. 1, but with three sub-goals involved instead of five. Thus, instead of five bracelets as in FIG. 1, there are only three bracelets in FIG. 2. Wrist bracelet 20 represents the first sub-goal, wrist bracelet 21 represents the second sub-goal, and wrist bracelet 22 represents the third sub-goal. And, instead of five numbers and five arrows, there are only three numbers and three arrows. As in FIG. 1, number one 6 and arrow 11 represent sub-goal one, number two 7 and arrow 12 represent sub-goal two, and number three 8 and arrow 13 represent sub-goal three.

In FIGS. 1 and 2, the number and arrow representing the current sub-goal in each wrist bracelet are filled in with color. The number and arrow representing the current sub-goal could alternatively be designed to have any attribute about them different from the other numbers and arrows in the same wrist bracelet so that the user can easily determine that the wrist bracelet is representing a particular sub-goal. This includes but is not limited to having the number and arrow representing the current sub-goal made larger than the other numbers and arrows. Further, in FIGS. 1 and 2 target 17 could alternatively be eliminated all together from the artwork.

The artwork for the wrist bracelets corresponding to the current invention can be designed slightly different or erratically different from the artwork used in FIGS. 1 and 2. There are an infinite number of ways to design the artwork for the wrist bracelets so that the user can easily determine which sub-goal each wrist bracelet is representing.

Alternatively, the arrows and numbers illustrated in the artwork could be substituted by any object or objects, including but not limited to numbers, letters, the Braille alphabet, stars, asterisks, x's, circles, squares, diamonds, hearts, smiley faces, upset faces, people, currency, basketballs, footballs, soccer balls, tennis balls, golf balls, trophies and or any combination thereof.

The wrist bracelets can be made from silicone material and wherein the artwork is debossed into the silicone wrist bracelets. However, depending upon the material chosen for the wrist bracelets, the artwork can alternatively be processed in different ways, including but no limited to embossing, painting, printing, stamping, engraving, embroidering, sewing, cutting and pasting, and carving.

In addition to the infinite number of artworks that can be used for the current system, there are an infinite number of other ways that the wrist bracelets can be designed so that they may represent the different sub-goals of a measurable goal. This includes but is not limited to using different colored wrist bracelets to represent the different sub-goals and using different quality bracelets to represent different sub-goals, or any combination thereof. For this to work, the user would need to be advised in some way, such as verbally or by means of a brochure or instruction manual, as to which sub-goal each color or quality represents. For example, a green wrist bracelet can represent sub-goal one, a white wrist bracelet can represent sub-goal two, a copper wrist bracelet can represent sub-goal three, a silver wrist bracelet represent sub-goal four, and a gold wrist bracelet represent wrist bracelet sub-goal five. The colors may be any color in the color spectrum, so long as the five bracelets are different colors.

An alternate embodiment of the instant invention alternatively uses the bracelets as a countdown system. For example, a countdown to a wedding date, where a wedding ring represents the wedding date and numbers five, four, three, two, and one each represent the steps or an amount of time leading to the wedding date. Because a countdown is a backward counting indicating the time remaining before an event occurs the numbers are arranged in reverse chronological order. The numbers representing the current step can be filled in with color so that the user can easily determine which step the wrist bracelet is representing. The artwork used to represent a countdown system can be done in an infinite number of ways. The key is for each wrist bracelet to represent a specific amount of time towards an event with an alternative additional bracelet representing the event.

The material used for the current invention's wrist bracelets is 100% silicone rubber. The wrist bracelets could alternatively be composed of any material, including but not limited to rubber, silicone rubber, styrene-butadiene rubber, polybutadiene, polychloroprene butyl rubber, natural rubber, partially vulcanized natural rubber, plastic, metal, wood, stone, leather, cotton, polyester, nylon, and silk.

The designations upon the bracelets can be accomplished using any known method including debossing, embossing, painting, printing, stamping, engraving, embroidering, sewing, cutting and pasting, and carving. Further, the designations upon the bracelets can be any artwork and not limited to the artwork disclosed herein. And finally, the bracelets can be identified through a color system instead of artwork, whereby each bracelet is a different color representing a different sub-goal.

Any and all other obvious modifications to one or more of the parts of this invention are inherently incorporated herein.

What is claimed is:

1. A set of wrist bracelets wherein each bracelet has a definitive designation thereupon, such that successive steps are defined by respective wrist bracelets that correlate to predetermined sub-goals of a desired main goal; wherein respective wrist bracelets are adapted to be worn on a user's wrist in correlation to the progress of each of said sub-goals until the main goal is achieved.

2. The post protector of claim 1, wherein said respective wrist bracelets are adapted to be worn on a user's wrist one at a time in correlation to the progress of said sub-goals and until the main goal is achieved.

3. The post protector of claim 1, wherein all said respective wrist bracelets are adapted to be placed on a user's wrist at once and initially, such that when each of said sub-goals is achieved that respective bracelet is removed from the user's wrist until all the bracelets are removed from the user's wrist and the main goal is achieved.

4. The post protector of claim 1, wherein each said definitive designation includes a series of numbers starting with the number one and through the number of sub-goals necessary to achieve the main goal, such that the number being designated by each respective wrist bracelet is displayed differently than the other numbers on that wrist bracelet, thereby signifying that number and its respective sub-goal are in progress.

5. The post protector of claim 1, wherein each said definitive designation includes a series of symbols defining successive sub-goals necessary to achieve the main goal, such that the symbol being designated by each respective wrist bracelet is displayed differently than the other symbols on that wrist bracelet, thereby signifying that symbol and its respective sub-goal is in progress.

6. The post protector of claim 1, wherein each said definitive designation includes a series of colors defining successive sub-goals necessary to achieve the main goal, such that the color being designated by each respective wrist bracelet is displayed differently than the other colors on that wrist bracelet, thereby signifying that color and its respective sub-goal is in progress.

7. The post protector of claim 1, wherein the set of wrist bands includes five wrist bands; each respective wrist band including the numbers 1 through five displayed thereon such that the first wrist band has the number one displayed using one color and the numbers two through five displayed as a different color, wherein the numbers two through five are all the same color, thereby highlighting the number one and signifying that the first sub-goal towards the main goal is in progress; the second wrist band has the number two displayed using one color and the numbers one and three through five displayed as a different color, wherein the numbers one and three through five are all the same color, thereby highlighting the number two and signifying that the second sub-goal towards the main goal is in progress; the third wrist band has the number three displayed using one color and the numbers one, two, four, and five displayed as a different color, wherein the numbers one, two, four, and five are all the same color, thereby highlighting the number three and signifying that the third sub-goal towards the main goal is in progress; the fourth wrist band has the number four displayed using one color and the numbers one through three, and five displayed as a different color, wherein the numbers one through three, and five are all the same color, thereby highlighting the number four and signifying that the fourth sub-goal towards the main is in progress; and the fifth wrist band has the number five displayed using one color and the numbers one through four displayed as a different color, wherein the numbers one through four are all the same color, thereby highlighting the number five and signifying that the final sub-goal towards the main goal is in progress.

8. The post protector of claim 1, wherein the wrist bands are formed from a group of materials that includes rubber, silicone rubber, styrene-butadiene rubber, polybutadiene, polychloroprene butyl rubber, natural rubber, partially vulcanized natural rubber, plastic, metal, wood, stone, leather, cotton, polyester, nylon, and silk.

9. The post protector of claim 1, wherein the definitive designation of each respective wrist bracelet can be formed from a list of designations that includes numbers, letters, colors, the Braille alphabet, stars, asterisks, x's, circles, squares, diamonds, hearts, smiley faces, upset faces, people, currency, basketballs, footballs, soccer balls, tennis balls, golf balls, trophies, logos, and any combination thereof.

10. A method of motivating including the steps of choosing a main goal; determining sub-goals that are necessary for achieving said main goal; incorporating a plurality of wrist bracelets that correlate to each respective sub-goal; placing said wrist bracelets on a user's wrist in correlation to the progress of each of said sub-goals until the main goal is achieved, to thereby provide visual reminders and motivation between and during each sub-goal until the main goal is achieved.

11. The post protector of claim 10, wherein said wrist bracelets are adapted to be worn on a user's wrist one at a time in correlation to the progress of said sub-goals and until the main goal is achieved.

12. The post protector of claim 10, wherein all said wrist bracelets are adapted to be placed on a user's wrist together at one time and initially, such that when each of said sub-goals is achieved that respective bracelet is removed from the user's wrist until all the bracelets are removed from the user's wrist and the main goal is achieved.

13. The post protector of claim 10, wherein each wrist bracelet includes a definitive designation; wherein said definitive designation includes a series of numbers starting with the number one and through the number of sub-goals necessary to achieve the main goal, such that the number being designated by each respective wrist bracelet is displayed differently than the other numbers on that wrist bracelet, thereby signifying that number and its respective sub-goal is in progress.

14. The post protector of claim 10, wherein each wrist bracelet includes a definitive designation; wherein said definitive designation includes a series of symbols defining successive sub-goals necessary to achieve the main goal, such that the symbol being designated by each respective wrist bracelet is displayed differently than the other symbols on that wrist bracelet, thereby signifying that symbol and its respective sub-goal is in progress.

15. The post protector of claim 10, wherein each wrist bracelet includes a definitive designation; wherein said definitive designation includes a series of colors defining successive sub-goals necessary to achieve the main goal, such that the color being designated by each respective wrist bracelet is displayed differently than the other colors on that wrist bracelet, thereby signifying that color and its respective sub-goal is in progress.

16. The post protector of claim 10, wherein the set of wrist bands includes five wrist bands; each respective wrist band including the numbers 1 through five displayed thereon such that the first wrist band has the number one displayed using one color and the numbers two through five displayed as a different color, wherein the numbers two through five are all the same color, thereby highlighting the number one and signifying that the first sub-goal towards the main goal has is in progress; the second wrist band has the number two displayed using one color and the numbers one and three through five displayed as a different color, wherein the numbers one and three through five are all the same color, thereby highlighting the number two and signifying that the second sub-goal towards the main goal is in progress; the third wrist band has the number three displayed using one color and the numbers one, two, four, and five displayed as a different color, wherein the numbers one, two, four, and five are all the same color, thereby highlighting the number three and signifying that the third sub-goal towards the main goal is in progress; the fourth wrist band has the number four displayed using one color and the numbers one through three, and five displayed as a different color, wherein the numbers one through three, and five are all the same color, thereby highlighting the number four and signifying that the fourth sub-goal towards the main goal is in progress; and the fifth wrist band has the number five displayed using one color and the numbers one through four displayed as a different color, wherein the numbers one through four are all the same color, thereby highlighting the number five and signifying that the final sub-goal towards the main goal is in progress.

17. The post protector of claim 10, wherein the wrist bands are formed from a group of materials that includes rubber, silicone rubber, styrene-butadiene rubber, polybutadiene, polychloroprene butyl rubber, natural rubber, partially vulcanized natural rubber, plastic, metal, wood, stone, leather, cotton, polyester, nylon, and silk.

18. A method of motivating comprising the steps of choosing a main goal; determining sub-goals that are necessary for achieving said main goal; incorporating a plurality of wrist bracelets that correlate to each respective sub-goal; and wearing said wrist bracelets on a user's wrist such that the progress of said sub-goals and said main goal can be visualized and followed.

19. The post protector of claim 18, wherein said wrist bracelets are placed on a user's wrist one at a time in correlation to the progress of each respective sub-goal, such that when a user achieves each sub-goal the bracelet that correlates to each respective sub-goal is placed on the user's wrist along with any other of said bracelets previously placed thereon until the main goal is achieved.

20. The post protector of claim 18, wherein all the wrist bracelets are initially placed on a user's wrist; then each respective wrist bracelet is removed from the user's wrist one at a time in correlation to the achievement of each respective sub-goal until there are no said bracelets remaining on the user's wrist and the main goal is achieved.
